(19) United States
(12) Patent Application Publication
(10) Pub. No.: US 2008/0270593 A1
(43) Pub. Date: Oct. 30, 2008

(54) Method and Devices for Distributing Management Information in a Management Network of a Communications System

(76) Inventor: Lucian Hirsch, Munchen (DE)

Correspondence Address: STAAS & HALSEY LLP, SUITE 700, 1201 NEW YORK AVENUE, N.W., WASHINGTON, DC, 20005, US

(21) Appl. No.: 11/547,431

(22) PCT Filed: Mar. 3, 2005
(86) PCT No.: PCT/EP2005/050934

§ 371 Date: Sep. 29, 2006

(30) Foreign Application Priority Data
Mar. 30, 2004 (DE) 10 2004 015 558.5

(51) Int. Cl. G06F 15/173

(52) U.S. Cl. 709/224

(57) ABSTRACT

A method for distributing management information in a management network for monitoring and controlling a communications system, whereby the management network comprises managers “NMC” and agents “OMC1-3” configured as devices on different management levels, with management information being transmitted as event reports between said devices of the management network.

### CROSS REFERENCE TO RELATED APPLICATIONS

This application is based on and hereby claims priority to PCT Application No. PCT/EP2005/050934, filed on Mar. 3, 2005 which claims priority to German Application No. 10 2004 015 558.5, filed on Mar. 30, 2004, the contents of which are hereby incorporated by reference.

### BACKGROUND

The invention relates to a method for distributing management information in a management network for monitoring and controlling a communications system.

The principles of a management network, also referred to as TMN principles (TMN: Telecommunications Management Network), define several management layers for the management of a communications system—for example, a mobile communications system—, whereby each layer, with the exception of the topmost and bottommost layer, has a dual function. In the managing system, each level, apart from the bottommost one, exercises a manager function for the next level down. In the managed system, each level, except for the topmost one, is given an agent function for the next layer up.

The ITU-T Standards of the Series X.73x define different systems management functions for the management of telecommunications networks, which can be used by application processes in a centralized or decentralized management environment.

The manager-agent communication is made via so-called management interfaces or manager-agent interfaces, which can be identified in an object-oriented environment by a communications protocol (e.g. CMIP (Common Management Information Protocol according to ITU-T X.711) or CORBA (Common Object Request Broker Architecture)) and an object model.

Such interfaces exist, for example, between, on the one hand, the element management level and, on the other hand, the network element level. An example for network devices to this interface (OMC BSS interface) is given by the operation and maintenance centers (OMC) on the element management level side and the base stations, for example, of the base station system (BSS) in a GSM mobile radio network on the network element level. The base stations of a second generation GSM network are referred to here by way of example. Base stations of other communications networks can also be affected, for example node B of a UMTS mobile network (UMTS Universal Mobile Telecommunication System) or radio access points of a WLAN system (WLAN Wireless Local Area Network) for example to one of the IEEE 812.11-standards.

Management interfaces or manager-agent interfaces do exist, but especially also between, on the one hand, the network management level and, on the other hand, the network element management level. These interfaces are central to the management network. An example for network devices to these interfaces (NMC-OMC interfaces or NM-EM interfaces) is given by the network management centers (NMC) on the network management level side and the operation and maintenance centers (OMC) on the element management level e.g. in the GSM mentioned or in another mobile radio network.

Services within the management network, which, for example, allow the operator to change the structure and hence the behavior of a telecommunication network, relate as a rule to instances of managed objects, which model network resources in an object-oriented environment and in all, form the network specific management information base (MIB).

A cellular structure is a basic principle for the configuration of the radio subsystem of a mobile network that has at least zone wide coverage. One precondition for the functionality of a mobile network is the correct definition of relationships between neighboring cells, also called adjacent cells.

From a “Management Information” perspective, such relationships are basically defined with the help of two object categories:
Cell: one instance of these managed object classes (MOC) defines one (reference) cell in a mobile network.
AdjacentCell: one instance of these managed object classes (MOC) defines one neighboring cell, which, relating to the reference cell, can be used for handover and/or reselection purposes.

In summary, it can be noted that complex telecommunication networks (such as, for example, mobile networks) commonly use management hierarchies in which element managers (OMC systems) play the agent role and network managers (NMC systems) play the manager role. Operations are carried out and management information is processed and stored both in network management centers (NMC) as well as in operation and maintenance centers (OMC).

In a multi-manager environment, each agent must be able, if need be, to handle requests from several managers, which requests run parallel to each other. A manager can only optimally fulfill its function if all relevant event reports from the subordinate agents are received. Under normal conditions, i.e. when the communication between an agent and the higher managers functions correctly, this occurs via a so-called event reporting mechanism. The task of said event reporting mechanism is to route to the manager only those event reports which satisfy certain filter criteria.

Ensuring the consistency of management information, even when individual NM-EM interfaces fail, is very important for an efficient network operation, especially in a hierarchical multi-manager configuration.

### SUMMARY OF THE INVENTION

One possible object is, therefore, to show a method, network devices and a communications system of the kind mentioned above, which can make an effective distribution of management information to all affected management systems (in particular in a kind of “broadcasting” functionality) via NM-EM interfaces possible.

The inventor proposes that, in each manager that functions as a network manager common resources of the communication system are identified in an object-oriented management hierarchy and management information is transmitted as event reports to all devices of the management network that are affected by an event and that function as network managers or as element managers, using the identification of the common resources and the interface between the manager and the agent.

In the case of network management centers (NMC) as managers and the operation and maintenance centers (OMC) as agents, this means that management information is transmitted as event reports to all network management centers (NMC) of the management network that are affected by an event and that function as network managers, and/or to operation and maintenance centers (OMC) of the management network that are affected by an event and that function as element managers, using the identification of the common resources and the NM-EM interface between the network management centre (NMC) and the operation and maintenance centre (OMC).

The interface to the manager-agent relationship between a network management centres (NMC) and an operation and maintenance centre (OMC) can be developed advantageously as a real-time interface. In this way, it is possible to ensure the consistency of management information between cells in neighboring network regions, using the real-time interface (real-time OMC-NMC management interface).

The basis for the method is the management and identification of so-called common resources in each network manager (NMC). In an object-oriented management hierarchy, resources of the telecommunication network that are managed in neighboring network regions by instances of different object classes are called common resources.

By way of example for this, one can regard the modeling of a single cell in a mobile radio network as a reference cell in an OMC region (an instance of the cell object class) and as neighboring cells for the adjacent OMC regions (several instances of the adjacentCell object class).

In one embodiment, the different object instances of a concrete network resource are given an identical identification, the so-called symbolic name, which represents an identifier that is defined by the operator, is valid network wide and can be modeled by the standardized attribute (ITU-T M.3100) userLabel. Consequently, in the method provision can be made in particular that the identification of a common resource of the communications system is done using the issuing of a symbolic name as an identifier that is valid within the communications system.

Advantageously in every manager (NMC) that functions as a network manager information on the allocation of the symbolic name to at least one corresponding object instance in the object-oriented management hierarchy can be stored. Because of this allocation information, it is possible to establish in a relatively simple manner, to which devices of the management network the event reports are to be distributed.

The management information can be transmitted as event reports to the devices (NMC and/or OMC) of the management network by an agent (operation and maintenance centre OMC) as the original sender, or by a manager (network management centre NMC) as the original sender. If the event reports originate from the element manager level (EM Level) of the operation and maintenance centers (OMC), the distribution of the management information starts with a transmission from the relevant operation and maintenance center (OMC) to the connected network management centers (NMC). Consequently, the management information is transmitted as event reports from at least one agent (OMC) to the connected manager (NMC) of the management network.

If the event reports originate from the network manager level (NM Level) of the network management centers (NMC), the distribution of the management information starts with a transmission from the relevant NMC to the connected operation and maintenance centers (OMC). In that case, the management information is transmitted as event reports from at least one manager (NMC) to the connected agents (OMC) of the management network.

In a further development, a multiple sending of identical event reports is avoided by each manager (NMC) and each agent (OMC) ignoring the receipt of an event report that has already been received and not forwarding it again to connected devices (NMC or OMC) of the management network. In this way, an unnecessary sending of event reports is effectively prevented.

Against the background of the measures described, it is possible to automate a distribution of the management information in a relatively simple way. The management information is distributed bidirectionally by all affected management systems via NM-EM interfaces, i.e. a kind of “broadcasting” functionality is made available. In addition to the redundancy of the communication links, this also enables the consistency of management information to be ensured both hierarchically (between OMCs and NMCs) as well as on the horizontal level (e.g. between neighboring OMCs).

In each manager (NMC) that functions as a network manager, information about the allocation of the symbolic name to at least one corresponding object instance in the object-oriented management hierarchy can be stored in the form of a table. Each time after an NM-EM link has been established, the NM system synchronizes the configuration data. Thus each network manager centre (NMC) builds up its own table, the lines of which each contain the allocation between a symbolic name and the corresponding object instance (distinguished name). A common resource is recognized if, in one table line, several instances (different object classes) are allocated to exactly one symbolic name.

The foregoing assumes that a network device (operation and maintenance centre OMC) is designed to function as an agent in a management network for monitoring and controlling a cellular communications system for at least one manager-agent relationship between a manager (network manager centre NMC) of a network management level (NM level) and the network device (operation and maintenance centre OMC) as an agent of the element management level (EM level). Management information is distributed as event reports to all devices (Network manager center NMC) of the management network that are affected by an event and that function as network managers (network manager centre NMC), using the identification of the common resources and the interface (NM-EM interface) between the manager (network manager centre NMC) and the agent (operation and maintenance centre OMC).

In the function as manager in a management network for monitoring and controlling a cellular communication system, there is a network management device (network manager centre NMC), which is designed for at least one manager-agent relationship between the network management device (NMC) of a network management level (NM LEVEL) and a network device (operation and maintenance centre OMC) as an agent of the element management level (EM LEVEL). Management information is transmitted as event reports to all devices (operation and maintenance centre OMC) of the management network that are effected by an event and that function as network element managers, using the identification of the common resources and the interface (NM-EM interface) between the manager (network manager centre NMC) and the agent (operation and maintenance centre OMC).

Further, the network management device (network manager centre NMC) may store information on the allocation of the symbolic name to at least one corresponding object instance in the object-oriented management hierarchy.

A communication system has a management network for monitoring and controlling the cellular communications system comprises both network devices described above (operation and maintenance centre OMC) functioning as agents and also network management devices described above (network manager centre NMC) functioning as managers, configured as devices on different management levels (EM LEVEL, NM LEVEL).

In principle, the method can be used in all communications networks and in particular telecommunication networks (in particular wireless, but also wire-bound). In the multi-manager configuration there are a large number of managers and a large number of agents.

In principle, the method can be used for all kinds of manager-agent interfaces. By way of example it is explained below using embodiments for a CMIP based NMC-OMC interface. However, the method can also be used in the same way or accordingly with other interface protocols (e.g. SNMP or CORBA).

### BRIEF DESCRIPTION OF THE DRAWINGS

These and other objects and advantages will become more apparent and more readily appreciated from the following description of the preferred embodiments, taken in conjunction with the accompanying drawings of which:

FIG. 1 the basic block diagram of a management network for a (mobile) communications system with agent-manager relationship between operation and maintenance centers and several network management centers,

FIG. 2 a block diagram of an exemplary cutout of a management network for a communications system with agent-manager relationship between four operation and maintenance centers and four network management centers,

FIG. 3 a schematic diagram of examples of different ways of distributing the management information in the form of event reports for the block diagram in FIG. 2,

FIG. 4 a schematic diagram of an exemplary distribution path for the management information in the form of event reports for the block diagram in FIG. 2 where the link between NMC₁ and OMC₂ fails,

FIG. 5 a schematic diagram of an exemplary distribution path for the management information in the form of event reports for the block diagram in FIG. 2 where the link between OMC₁ and NMC₂ fails.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

FIG. 1 shows the block diagram of a management network for a mobile communications system with agent-manager relationship between operation and maintenance centers OMC₁, OMC₂ to OMCₙ (operation and maintenance centers) and several network management centers NMC₁, NMC₂, NMC₃ to NMCₙ (network management centers). In this case, in FIG. 1 the representation is limited to two levels NM LEVEL and EM LEVEL. Not shown, for example, is a management level of the management network, which level contains the network device level (network element level) with several base station systems.

The management level EM LEVEL identifies the network element management level, in which the operation and maintenance centers OMC₁, OMC₂ to OMCₙ respectively provide the usually manufacturer specific management functionality for, for example, individual base stations of the base station system not shown in FIG. 1. The management level NM LEVEL identifies the network management level, in which network management centers NMC₁, NMC₂, NMC₃ to NMCₙ respectively realize an integrated management functionality that is usually independent of the manufacturer. Thereby, several network management centers NMC can have access to the same network device of the next lower management level EM LEVEL, in this example, for example, the network management centers NMC₁ and NMC₂ of the next higher management level NM LEVEL to the operation and maintenance centre OMC₂ of the next lower management level EM LEVEL. Between the network devices of different management levels with the operation and maintenance centers OMC₁, OMC₂ to OMCₙ on the one hand and the network management centers NMC₁, NMC₂, NMC₃ to NMCₙ on the other hand, there are defined interfaces NM-EM-IF (NM-EM interface) for transmitting information. FIG. 1 shows a multi-manager configuration of a management network.

In the following we will first look at the distribution of event reports originating on EM LEVEL.

These are event reports that have either occurred spontaneously in operation and maintenance centers OMC or associated network elements or were triggered by an operator action, e.g.:

alarms

alarm acknowledgement (alarm acknowledgement notification in accordance with 3GPP TS 32.111)

Manual alarm clearing (alarm clearing notification in accordance with 3GPP TS 32.111)

Change of attribute values.

For the distribution of event reports from an operation and maintenance centre OMC to the connected network management centers NMC, it is assumed that on each NM-EM interface NM-EM-IF, the network management centre NMC has set up a filter mechanism (e.g. in the form of an EFD Event Forwarding Discriminator) in operation and maintenance centre OMC and has set the filter criteria.

The operation and maintenance centre OMC forwards each event report (e.g. M EVENT REPORT in the case of a CMIP based NM-EM interface) to all NMC specific filter mechanisms. Thus each network management centre NMC can control the information flow according to its own individual requirements, i.e. from the view of the network management centre NMC, undesired reports are already filtered out in the operation and maintenance centre OMC.

The event report received by a network management centre NMC is further distributed to other operation and maintenance centers OMC as follows: after receiving an event report, each network management centre NMC checks whether the object instance (to which the current event report refers) exists as a common resource in the table of the configuration data.

If that is the case, then the event report is also of significance for other neighboring operation and maintenance centers OMC. For each further object instance of this table line the network management centre NMC sends a corresponding request (e.g. M-ACTION or M-SET in the case of a CMIP based NM-EM interface) to the respective connected operation and maintenance centre OMC.

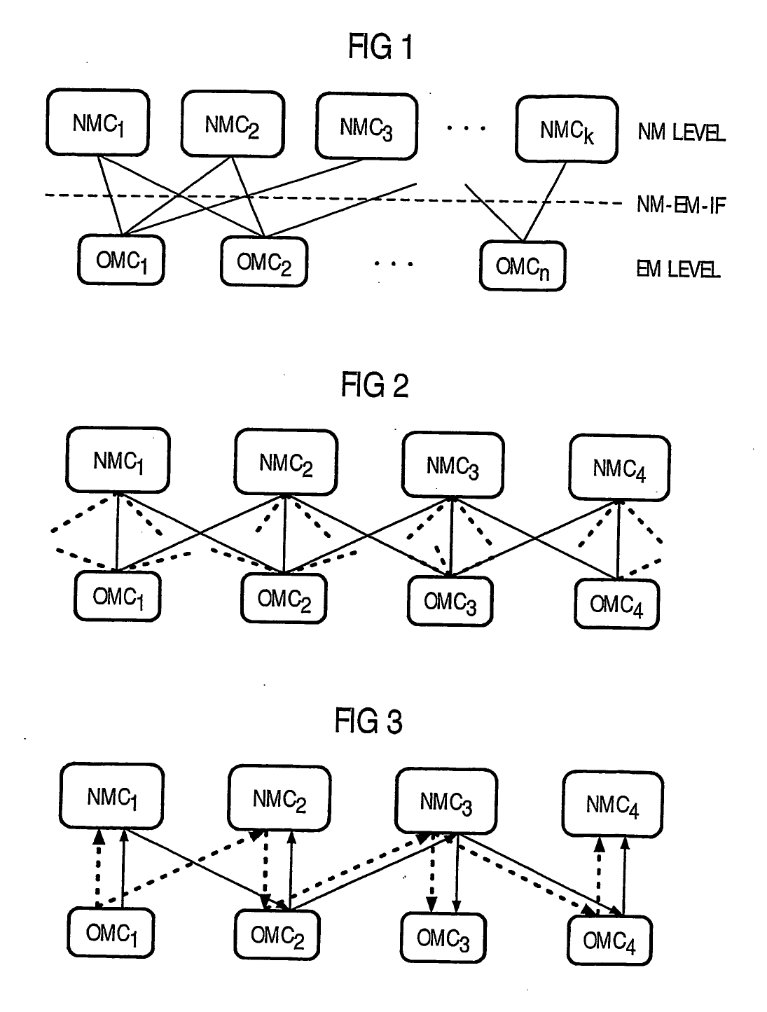

In one example, a management hierarchy with several EM and NM systems is assumed, whereby only the neighboring EM systems OMC₁, OMC₂, OMC₃, OMC₄ are of relevance here. A scenario of this kind is represented schematically in FIG. 2. FIG. 2 shows a block diagram of a cutout of a management network for a communications system with agent-manager relationship between four operation and maintenance centers OMC₁, OMC₂, OMC₃ and OMC₄ and four network management centers NMC₁, NMC₂, NMC₃ and NMC₄. As well as connections of network management centers NMC₁, NMC₂, NMC₃ and NMC₄ and operation and maintenance centers OMC₁, OMC₂, OMC₃ and OMC₄ portrayed by unbroken lines, connections to additional network devices (NMC or OMC) that may exist in the levels NM LEVEL and EM LEVEL but are not represented in FIG. 2, are indicated by dotted lines.

A reference cell (cell₁) is defined in the network area monitored by the operation and maintenance centre OMC₁. This cell is at the same time an adjacent cell for the network regions monitored by operation and maintenance centers OMC₂, OMC₃ and OMC₄ and correspondingly defined (adjacentCell₂₁, adjacentCell₃₁, adjacentCell₄₁).

FIG. 3 shows a schematic diagram of examples of different paths for distributing the management information in the form of event reports for the block diagram in FIG. 2.

An alarm of the object instance cell₁ occurs and a corresponding alarm report is sent by the operation and maintenance centre OMC₁ to the connected network management centers NMC₁ (broadcasting path 1, unbroken arrow in FIG. 3) and NMC₂ (broadcasting path 2, broken arrow in FIG. 3).

A first distribution path of the management information in the form of event reports (broadcasting path 1) goes via the network management centre NMC₁, which also communicates with the operation and maintenance centre OMC₂: using its own table on common resources, the network management centre NMC₁ recognizes the relationship between the instances cell₁₁ and adjacentCell₂₁ and forwards an “alarm” notification to the connected operation and maintenance centre OMC₂. Here the alarm (for the adjacentCell₂₁ instance) is entered into the OMC₂ own alarm list and subsequently forwarded as an alarm notification to all other connected NMC systems (network management centers NMC₂ and NMC₃). The network management centre NMC₂ has already received the alarm from the operation and maintenance centre OMC₁, which is why the alarm notification is ignored by the operation and maintenance centre OMC₂.

The network management centre NMC₃, which has received the alarm from operation and maintenance centre OMC₂ and in addition communicated with the operation and maintenance centers OMC₃ and OMC₄, recognizes the relationship between the object instances adjacentCell₂₁, adjacentCell₃₁ and adjacentCell₄₁ in its own table for common resources and forwards an “alarm” notification to the other connected operation and maintenance centers OMC₃ and OMC₄.

In operation and maintenance centre OMC₃, the alarm (for the adjacentCell₃₁ instance) is entered into the alarm list. The operation and maintenance centers OMC₄ also enters the alarm (for the adjacentCell₄₁ instance) into its own alarm list and subsequently forwards an alarm notification to the connected network management centre NMC₄. Thus all affected management systems have taken note of the alarm in the cell cell₁.

A similar forwarding of the alarm runs via a second distribution path (broadcasting path 2, broken arrow in FIG. 3) via the network management centre NMC₂.

From FIG. 3 can be seen that the bidirectional “broadcasting” functionality could cause a doubling of the message transmission. It is, however, possible to avoid multiple sending of the same event reports if each management system in the management network does not forward a notification that has already been received before and simply ignores it (in the way NMC₂ ignores the alarm from OMC₂—see embodiments above).

On the other hand, the existing redundancy is important to ensure the consistency of the management information even when a connection between network management centre and operation and maintenance centre (NM-EM connection) has failed.

FIG. 4 shows a schematic diagram of a model distribution path of the management information in the form of event reports for the block diagram in FIG. 2 when the connection between network management centre NMC, and operation and maintenance centre OMC₂ has failed. FIG. 4 illustrates the forwarding of the above mentioned alarm when the connection between network management centre NMC₁ and operation and maintenance centre OMC₂ has failed. This corresponds to the forwarding of the alarm via a second distribution path (broadcasting path 2, broken arrow) in FIG. 3. In detail, the distribution path of the event report or alarm report comprises the following connections:

Connection (or transmission path) A: from OMC₁ to NMC₁

Connection (or transmission path) B: from OMC₁ to NMC₂

Connection (or transmission path) C: from NMC₂ to OMC₂

Connection (or transmission path) D: from OMC₂ to NMC₃

Connection (or transmission path) E: from NMC₃ to OMC₃

Connection (or transmission path) F: from NMC₃ to OMC₄

Connection (or transmission path) G: from OMC₄ to NMC₄.

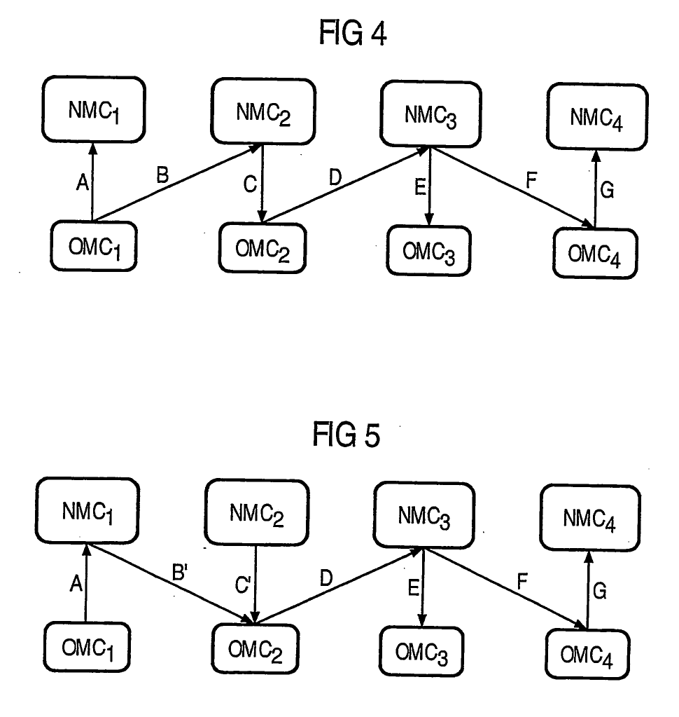

FIG. 5 shows a schematic diagram of another model distribution path of the management information in the form of event reports for the block diagram in FIG. 2 when the connection between operation and maintenance centre OMC₁ and network management centre NMC₂ has failed. FIG. 5 also reproduces the forwarding of the above mentioned alarm, in the case that the connection between operation and maintenance centre OMC₁ and network management centre NMC₂ has failed. This corresponds to the forwarding of the alarm via the first distribution path (broadcasting path 1, unbroken arrow) in FIG. 3. In detail, the distribution path of the event report or alarm report comprises the following connections:

Connection (or transmission path) A: from OMC₁ to NMC₁

Connection (or transmission path) B′: from NMC₁ to OMC₂

Connection (or transmission path) C′: from OMC₂ to NMC₂

Connection (or transmission path) D: from OMC₂ to NMC₃

Connection (or transmission path) E: from NMC₃ to OMC₃

Connection (or transmission path) F: from NMC₃ to OMC₄

Connection (or transmission path) G: from OMC₄ to NMC₄

In addition to the distribution of event reports whose origin is on EM LEVEL, there can also be a distribution of event reports whose origin is on NM LEVEL. Here the event reports are triggered by an operator action at the network management centre NMC, e.g.:

Alarm acknowledgement (alarm acknowledgement operation in accordance with 3GPP TS 32.111)

Manual alarm clearing (alarm clearing operation in accordance with 3GPP TS 32.111)

Change of attribute values.

An example here would be the changing of a handover attribute in the cell cell₁ by the operator at the network management centre NMC₁. As this parameter is also relevant for the object instances adjacentCell₂₁, adjacentCell₃₁, adjacentCell₄₁, the change must be notified to all neighboring OMC areas. The distribution (broadcast functionality) proceeds in a similar way to that described above, but this time network management centre NMC₁ is the starting point. This would mean that the distribution via path A in FIGS. 4 and 5 would reverse direction from the network management centre NMC₁ to the operation and maintenance centre OMC₁.

The example of the method is described using a Q3 (CMIP based) interface. The method can also be applied accordingly on other interfaces, such as, for example, CORBA based interfaces.

In summary, the following features of the method can be noted:

The method allows automatic updating of management information both between OMCs and NMCs and also between neighboring OMCs.

The consistency of data across all EM and NM systems (operation and maintenance centers OMC and network management centers NMC) is secured even when individual NM-EM connections fail.

In principle, the method can be used for all telecommunication networks.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-12. (canceled)

13. A method for distributing management information in a management network for monitoring and controlling a communications system, the management network having devices on different management levels comprising managers and agents, the method comprising:
by each network manager characterizing common resources of the communications system according to an object-oriented management hierarchy;
transmitting management information relating to events as event reports, each event report being transmitted to reach all network managers or element managers that are affected by the event; and
in transmitting event reports using the characterization of the common resources and of the interface between manager and agent.

14. The method according to claim 13, wherein
the characterization of the common resources of the communications system is carried out by issuing a symbolic name as an identifier valid within the communications system.

15. The method according to claim 14, wherein
each network manager stores information about an allocation of the symbolic name for at least one corresponding object instance in the object-oriented management hierarchy.

16. The method according to claim 13, wherein
management information is transmitted as event reports from an agent as the original sender or from a manager as the original sender to the devices of the management network.

17. The method according to claim 13, wherein
management information is transmitted as event reports from each agent to the managers of the management network connected to the agent.

18. The method according to claim 13, wherein
management information is transmitted as event reports from each manager to the agents of the management network connected to the manager.

19. The method according to claim 13, wherein
a multiple sending of identical event reports is avoided by each manager and each agent ignoring an already received event report when it is received again.

20. The method according to claim 15, wherein
each manager stores the information about the allocation of the symbolic name for at least one corresponding object instance, the information being stored in the form of a table.

21. The method according to claim 16, wherein
management information is transmitted as event reports from each agent to the managers of the management network connected to the agent.

22. The method according to claim 21, wherein
management information is transmitted as event reports from each manager to the agents of the management network connected to the manager.

23. The method according to claim 22, wherein
a multiple sending of identical event reports is avoided by each manager and each agent ignoring an already received event report when it is received again.

24. The method according to claim 23, wherein
each manager stores the information about the allocation of the symbolic name for at least one corresponding object instance, the information being stored in the form of a table.

25. A network device functioning as an agent in a management network for monitoring and controlling a cellular communications system, the network device functioning as the agent on an element management level in the network, the network device functioning as the agent in a manager-agent relationship with a manager on a network management level, the network device comprising:
means for characterizing common resources of the communications system according to an object-oriented management hierarchy;
a transmitter to transmit management information regarding events via event reports, each event report being sent to all network managers of the management network that are affected by the respective event, the transmitter using the characterization of the common resources and of the interface.

26. A network management device functioning as a manager in a management network for monitoring and controlling a cellular communications system, the network management device functioning as the manager on a network management level in the network, the network management device functioning as the manager in a manager-agent relationship with an agent on an element management level, the network management device comprising:
means for characterizing common resources of the communications system according to an object-oriented management hierarchy;
a transmitter to transmit management information regarding events via event reports, each event report being sent to all element managers of the management network that are affected by the respective event, the transmitter using the characterization of the common resources and of the interface.

27. The network management device according to claim 26,
wherein the common resources of the communications system are characterized by issuing a symbolic name as an identifier valid within the communications system, and
the network management device has a memory to store information on an allocation of the symbolic name for at least one corresponding object instance in the object-oriented management hierarchy.

28. A communications system with a management network for monitoring and controlling the communications system, comprising:
managers on a network manager management level; and
agents on an element manager management level, the managers and agents forming manager-agent relationships, the managers and agents comprising means for characterizing common resources of the communications system according to an object-oriented management hierarchy;
each manager comprises a transmitter to transmit management information regarding events via event reports, each event report being sent to all agents of the management network that are affected by the respective event, the transmitter using the characterization of the common resources and of the interface;
each agent comprises a transmitter to transmit management information regarding events via event reports, each event report being sent to all managers of the management network that are affected by the respective event, the transmitter using the characterization of the common resources and of the interface.

29. A method for distributing management information in a management network for monitoring and controlling a communications system, the management network having devices comprising managers on a network manager management level and agents on an element manager management level, the managers and agents forming manager-agent relationships, each manager-agent relationship involving communication over an interface between the manager and the agent, using common resources, the common resources being communication resources common to the manager and the agent, the method comprising:
transmitting management information relating to events as event reports, each event report being transmitted between the devices of the management network to reach all devices that are affected by the event;
in transmitting event reports, identifying the interface and common resources involved, the interface and common resources being identified in an object-oriented management hierarchy by the manager; and
using the common resources and of the interface information to enable transmission of events reports between managers and agent.
